(19) United States
(12) Patent Application Publication
(10) Pub. No.: US 2015/0338787 A1
(43) Pub. Date: Nov. 26, 2015

(54) IMAGE FORMING APPARATUS

(71) Applicant: CANON KABUSHIKI KAISHA, Tokyo (JP)

(72) Inventor: Mio Matsushita, Tokyo (JP)

(21) Appl. No.: 14/719,202

(22) Filed: May 21, 2015

(30) Foreign Application Priority Data
May 23, 2014 (JP) 2014-107609

(51) Int. Cl. G03G 15/00; G03G 15/16

(52) U.S. Cl. CPC G03G 15/161

(57) ABSTRACT

An image forming apparatus includes a first photosensitive drum having a first outer diameter, a second photosensitive drum having a second outer diameter larger than the first outer diameter, an intermediate transfer belt, a first primary transfer roller, a second primary transfer roller, and a cleaning unit configured to electrostatically remove toner attached to the intermediate transfer belt, and can perform a first image forming mode, in which the first and second photosensitive drums and the intermediate transfer belt contact each other, and a second image forming mode in which the first photosensitive drum and the intermediate transfer belt are separated from each other, and a pressing force applied from the second primary transfer roller to the second photosensitive drum is larger than a pressing force applied from the first primary transfer roller to the first photosensitive drum.

### BACKGROUND OF THE INVENTION

1. Field of the Invention

The present invention relates to an image forming apparatus such as a copy machine, a printer, and a facsimile apparatus using the electrophotographic method.

2. Description of the Related Art

Conventionally, as an image forming apparatus using the electrophotographic method, there has been a tandem-type image forming apparatus including a plurality of image forming units disposed along a rotational path of an intermediate transfer member to form a full color image. Generally, an intermediate transfer belt formed as an endless belt is used as the intermediate transfer member.

In the tandem-type image forming apparatus based on the intermediate transfer method, the moving intermediate transfer member and an electrophotographic photosensitive member (a photosensitive member) are brought into contact with each other at a primary transfer portion, whereby the intermediate transfer member and the electrophotographic photosensitive member are gradually wearing, and surface characteristics thereof are gradually changing at contact portions due to friction and a contact pressure. Even when there is an unused photosensitive member, for example, at the time of formation of a black monochrome image, if the unused photosensitive member is still brought into contact with the intermediate transfer member, a lifetime of this photosensitive member may be unnecessarily reduced. Especially, if the photosensitive member and the intermediate transfer member are conveyed at different speeds, a front layer of the photosensitive member may be scraped by a significantly increased amount, which may result in a reduction in the lifetime of the photosensitive member.

To solve this problem, Japanese Patent Application Laid-Open No. 7-261496 discusses an image forming apparatus including a mechanism that, in a black monochrome mode, causes photosensitive members of image forming units for other colors and an intermediate transfer member not to be contact with each other. Further, especially among full color copy machines for office use or the like, there is an image forming apparatus adopting a large diameter only for a drum-shaped photosensitive member of an image forming unit for the black color that is supposed to be most frequently used.

On the other hand, as a method for cleaning a toner image that is left on the intermediate transfer member after the toner image is transferred from the intermediate transfer member onto a recording medium, there is a method for removing toner by electrostatically attracting the toner, which is called an electrostatic cleaning method.

In the case where the above-described electrostatic cleaning method is employed as the method for cleaning the intermediate transfer member, an electric field is applied at an electrostatic cleaning portion to remove the toner, whereby an electrostatic attraction force is induced due to a charge between an electrostatic cleaning member and the intermediate transfer member. This attraction force changes according to a change in the charge. For example, the charge is changed depending on whether the toner exists, a charge amount of the toner, a residual charge amount of the intermediate transfer member after application of a voltage at a secondary transfer portion, an unevenness of a resistance of each of the intermediate transfer member and the electrostatic cleaning member alone, and the like.

A patch that is an adjustment toner image, such as a density patch used for acquiring a desired image density, and a registration patch used for correcting color misregistration, may be formed on the intermediate transfer member, instead of transfer residual toner after a secondary transfer at the time of normal image formation. Further, a secondary transfer member may be separated from the intermediate transfer member to prevent toner of the patch from being attached to the secondary transfer member. In this case, the toner of the patch has to be collected at the transfer cleaning portion while remaining unaffected by the electric field, whereby a charge amount of the toner of the patch is maintained negative in polarity and a total amount thereof is also significantly larger than the transfer residual toner at the time of the normal image formation. Therefore, especially when the toner of such a patch enters the electrostatic cleaning portion, a large change occurs in the attraction force between the electrostatic cleaning portion and the intermediate transfer member, which affects a speed of the intermediate transfer member rotating while contacting the electrostatic cleaning portion at a relative speed set relative to the electrostatic cleaning portion. As a result, the speed is easily changed.

On the other hand, in the case where the photosensitive members have different diameters among them while primary transfer members have equal diameters among them, a size of a nip is larger at the primary transfer portion of the image forming unit corresponding to the photosensitive member larger in diameter than the other image forming units. Therefore, when equal pressures are applied to the primary transfer portions, a pressure per unit area is lower at the image forming unit corresponding to the photosensitive member large in diameter. Therefore, the image forming unit using the photosensitive member larger in diameter is susceptible to an influence of the change in the speed of the intermediate transfer member.

Especially, in the case where the photosensitive members of the image forming units for the other colors are configured to be separated from the intermediate transfer member in the black monochrome mode as described above, this means that the intermediate transfer member is sandwiched by the primary transfer member and the photosensitive member of the single image forming unit, whereby this image forming unit is susceptible to the influence of the change in the speed of the intermediate transfer member. If this change in the speed is transmitted to the primary transfer portion, a micro slip may occur at the primary transfer portion, which may facilitate a movement of the toner within the nip, resulting in occurrence of toner scattering. This scattering may noticeably appear in a halftone image or the like, and a difference between a portion where the toner scatters and a portion where the toner does not scatter may be visualized by being expressed as a density unevenness in the image (an uneven image).

The above-described change in the speed of the intermediate transfer member less likely occurs in a configuration in which the patch is collected by attaching the patch to the secondary transfer member, or a configuration employing a blade cleaning method as the method for cleaning the intermediate transfer member.

### SUMMARY OF THE INVENTION

According to an aspect of the present invention, an image forming apparatus includes a first photosensitive drum, having a first outer diameter, configured to bear a toner image, a second photosensitive drum, having a second outer diameter larger than the first outer diameter, configured to bear a toner image, an endless movable intermediate transfer belt configured to temporarily bear the toner images, the toner images being transferred from the first and second photosensitive drums and then transferred onto a recording medium, first and second transfer rollers configured to electrostatically transfer the toner images formed on the first and second photosensitive drums onto the intermediate transfer belt, respectively, a first urging member configured to urge the first transfer roller toward the first photosensitive drum across the intermediate transfer belt with a first urging force, a second urging member configured to urge the second transfer roller toward the second photosensitive drum across the intermediate transfer belt with a second urging force larger than the first urging force, a cleaning member configured to electrostatically remove toner on the intermediate transfer belt at a cleaning portion located upstream of a primary transfer portion and downstream of a secondary transfer portion in a rotational direction of the intermediate transfer belt, a switching unit configured to switch a first image forming mode and a second image forming mode, the first and second photosensitive drums and the intermediate transfer belt being brought into contact with each other to transfer the toner images from the first and second photosensitive drums onto the intermediate transfer belt in the first image forming mode, the second photosensitive drum and the intermediate transfer belt being brought into contact with each other to transfer the toner image from the second photosensitive drum onto the intermediate transfer belt with the first photosensitive drum and the intermediate transfer belt being separated from each other in the second image forming mode, and an execution portion configured to pass an adjustment toner image through the cleaning portion after forming the adjustment toner image on the intermediate transfer belt in the second image forming mode.

Further features of the present invention will become apparent from the following description of exemplary embodiments with reference to the attached drawings.

### BRIEF DESCRIPTION OF THE DRAWINGS

FIG. 1 is a cross-sectional view illustrating an overview of an image forming apparatus (in a full color mode).

FIG. 2 is a cross-sectional view illustrating an overview of the image forming apparatus (in a black monochrome mode).

FIG. 3 is a cross-sectional view illustrating an overview of a belt cleaning device.

FIG. 4 is a control block diagram of main portions of the image forming apparatus.

FIG. 5 is a schematic cross-sectional view illustrating a support member that supports an intermediate transfer belt by pressing the intermediate transfer belt.

FIG. 6 is a schematic view illustrating a shift amount of a primary transfer roller.

FIG. 7 is a schematic cross-sectional view illustrating a structure of layers of the intermediate transfer belt.

### DESCRIPTION OF THE EMBODIMENTS

In the following description, image forming apparatuses according to exemplary embodiments of the present invention will be described in further detail with reference to the drawings.

### 1. Overall Configuration and Operation of Image Forming Apparatus

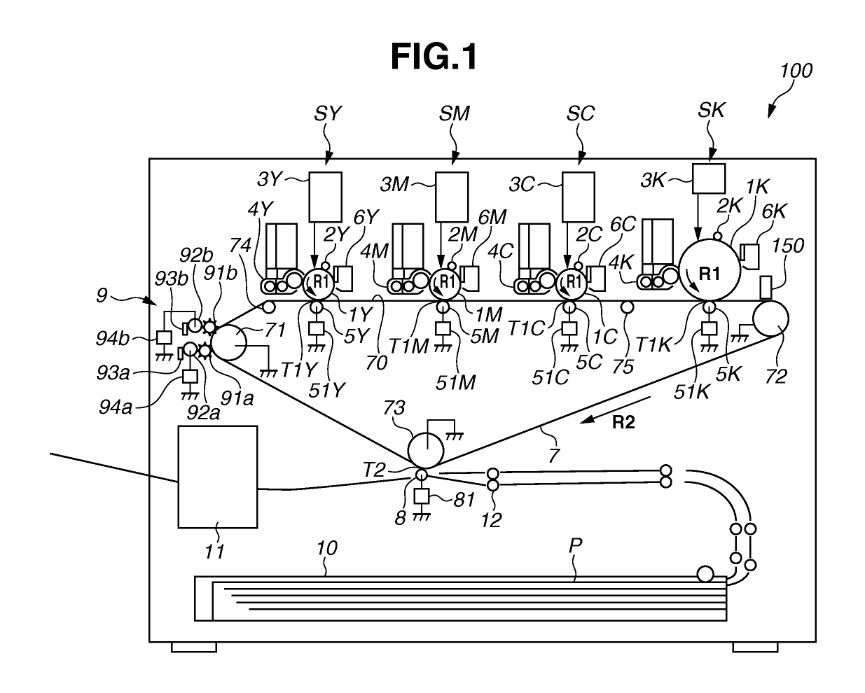

FIG. 1 is a cross-sectional view illustrating an overview of an image forming apparatus according to a first exemplary embodiment of the present invention. The image forming apparatus 100 according to the present exemplary embodiment is a tandem-type laser beam printer employing the intermediate transfer method, which can form a full color image on a transfer medium (recording paper, an overhead projector (OHP) sheet, a fabric, or the like) with use of the electrophotographic method.

The image forming apparatus 100 includes first, second, third, and fourth image forming units SY, SM, SC, and SK as a plurality of image forming units (stations). Theses image forming units SY, SM, SC, and SK form yellow (Y), magenta (M), cyan (C), and black (K) images, respectively. In the present exemplary embodiment, the respective image forming units SY, SM, SC, and SK have a lot in common in terms of configurations and operations thereof except for a difference in color of toner used therein. Therefore, hereinafter, components in the first to fourth image forming units SY, SM, SC, and SK will be described collectively, omitting alphabets Y, M, C, and K that are added at the ends of reference numerals for indicating which color that component is provided for, unless there is a necessity for distinguishing them especially.

The image forming unit S includes a photosensitive drum 1, which is a drum-shaped (cylindrical) electrophotographic photosensitive member (photosensitive member) as a rotatably disposed image bearing member. The photosensitive drum 1 is rotationally driven in a direction indicated by an arrow R1 in the FIG. 1 by a driving motor (not illustrated) as a driving unit. The following process devices are disposed around the photosensitive drum 1. First, a charging roller 2 as a charging unit is disposed. Next, an exposure device 3 as an exposure unit is disposed. Next, a development device 4 as a development unit is disposed. Next, a drum cleaning device 6 as a photosensitive member cleaning unit is disposed. Yellow toner, magenta toner, cyan toner, and black toner are contained in the development devices 4Y, 4M, 4C, and 4K of the image forming units SY, SM, SC, and SK, respectively. Further, in the present exemplary embodiment, the photosensitive drum 1K has a larger diameter at the fourth image forming unit SK than diameters at the other image forming units SY, SM, and SC.

An intermediate transfer belt 7 configured of an endless belt as an intermediate transfer member is disposed opposing the respective photosensitive drums 1 of the image forming units S. The intermediate transfer belt 7 is held by a driving roller 71, a tension roller 72, a secondary transfer counter roller 73, and push-up rollers 74 and 75 as support members (stretching rollers). The driving roller 71 transmits driving force to the intermediate transfer belt 7. The tension roller 72 applies a predetermined tensile force to the intermediate transfer belt 7. The secondary transfer counter roller 73 serves as a counter member (an opposing electrode) for a secondary transfer roller 8, which will be described below. The push-up rollers 74 and 75 form a primary transfer plane 70 for transferring a toner image onto the intermediate transfer belt 7. The four image forming units SY, SM, SC, and SK are arranged in series along a horizontal portion of the primary transfer plane 70. The driving roller 71 is rotationally driven by a driving motor (not illustrated) as a driving unit, such as a pulse motor. With this rotation, the intermediate transfer belt 7 is rotated (circulated) in a direction indicated by an arrow R2 in FIG. 1 (hereinafter also referred to as a “rotational direction” or a “conveyance direction”). The stretching rollers other than the driving roller 71 are rotated by being driven by the rotation of the intermediate transfer belt 7.

A primary transfer roller 5, which is a roller-shaped primary transfer member as a primary transfer unit, is disposed on an inner circumferential surface (back surface) side of the intermediate transfer belt 7 at a position opposing each of the photosensitive drums 1 of the image forming units S. The primary transfer roller 5 is urged (pressed) toward the photosensitive drum 1 via the intermediate transfer belt 7 to form a primary transfer portion (a primary transfer nip) T1 where the intermediate transfer belt 7 and the photosensitive drum 1 are in contact with each other. Further, the secondary transfer roller 8, which is a roller-shaped secondary transfer member as a secondary transfer unit, is disposed on an outer circumferential surface (front surface) side of the intermediate transfer belt 7 at a position opposing the secondary transfer counter roller 73. The secondary transfer roller 8 is urged (pressed) toward the secondary transfer counter roller 73 via the intermediate transfer belt 7 to form a secondary transfer portion (a secondary transfer nip) T2 where the intermediate transfer belt 7 and the secondary transfer roller 8 are in contact with each other. Further, a belt cleaning device 9 as an intermediate transfer member cleaning unit (a cleaning unit) is disposed on the outer circumferential surface side of the intermediate transfer belt 7 at a position opposing the driving roller 71.

The rotating photosensitive drum 1 is evenly charged by the charging roller 2. The charged photosensitive drum 1 is exposed by the exposure device 3 according to image information, and an electrostatic latent image (an electrostatic image) according to the image information is formed on the photosensitive drum 1. The toner of the color corresponding to each of the image forming units S is supplied from the development device 4, by which the electrostatic latent image formed on the photosensitive drum 1 is developed as a toner image. The toner image formed on the photosensitive drum 1 is transferred (primarily transferred) onto the rotating intermediate transfer belt 7 at the primary transfer portion T1 with the operation of the primary transfer roller 5. At this time, a primary transfer bias (a primary transfer voltage), which is a direct-current voltage having an opposite polarity from a charged polarity (a normal charged polarity) of the toner at the time of the development, is applied from a primary transfer power source 51 as a bias application unit to the primary transfer roller 5, by which a primary transfer electric field is generated at the primary transfer portion T1. In the present exemplary embodiment, the primary transfer power sources 51Y, 51M, 51C, and 51K are connected to the primary transfer rollers 5Y, 5M, 5C, and 5K of the image forming units SY, SM, SC, and SK, respectively. For example, when a full color image is formed, the toner images of the respective yellow, magenta, cyan, and black colors formed at the image forming units S are sequentially transferred onto the intermediate transfer belt 7 at the respective primary transfer portions T1 so as to be superimposed one after another on the intermediate transfer belt 7.

The toner images transferred onto the intermediate transfer belt 7 are transferred (secondarily transferred) onto a transfer medium P at the secondary transfer portion T2 with the operation of the secondary transfer roller 8. At this time, a secondary transfer bias (a secondary transfer voltage), which is a direct-current voltage having the opposite polarity from the normal charged polarity of the toner, is applied from a secondary transfer power source 81 as a bias application unit to the secondary transfer roller 8, by which a secondary transfer electric field is generated at the secondary transfer portion T2. Further, by this time, the recording medium P is supplied from a sheet feed cassette 10, and is conveyed to the secondary transfer portion T2 at a predetermined timing after being temporarily stopped at a registration roller 12. The transfer medium P with the toner images being transferred thereon is conveyed to a fixing device 11. At the fixing device 11, the toner images are fixed (fixedly attached) onto the transfer medium P by heat and a pressure. After that, the transfer medium P is discharged (output) to the outside of an apparatus main body of the image forming apparatus 100.

Transfer residual toner on the photosensitive drum 1 that is not transferred onto the intermediate transfer belt 7 and left thereon during the primary transfer process is removed and collected from the photosensitive drum 1 by the drum cleaning device 6. Further, transfer residual toner left on the intermediate transfer belt 7 that is not transferred onto the transfer medium P during the secondary transfer process is removed and collected from the intermediate transfer belt 7 by the belt cleaning device 9.

### 2. Configuration of Each Unit

### 2-1. Photosensitive Drum

The photosensitive drum 1 is formed by coating an organic photo conductor layer (OPC) on an outer circumferential surface of an aluminum cylinder. The photosensitive drum 1 is rotatably supported at both ends in a longitudinal direction thereof (a direction along a rotational axis) by flanges, and is rotationally driven by transmission of a driving force from the driving motor (not illustrated) to one of the ends. In the present exemplary embodiment, a charged polarity of the photosensitive drum 1 is a negative polarity.

In the present exemplary embodiment, the photosensitive drums 1Y, 1M, and 1C of the first, second, and third image forming units SY, SM, and SC, which are the image forming units for the respective yellow, magenta, and cyan colors, each have an outer diameter of φ30 (mm) (in the present exemplary embodiment, the photosensitive drums 1Y, 1M, and 1C will be also referred to as “photosensitive drums small in diameter”). On the other hand, the photosensitive drum 1K of the fourth image forming unit SK, which is the image forming unit for the black color, has an outer diameter of φ84 (mm) (in the present exemplary embodiment, the photosensitive drum 1K will be also referred to as a “photosensitive drum large in diameter”). In other words, only the photosensitive drum 1K for the black color is larger than the photosensitive drums 1Y, 1M, and 1C for the other colors.

### 2-2. Charging Roller

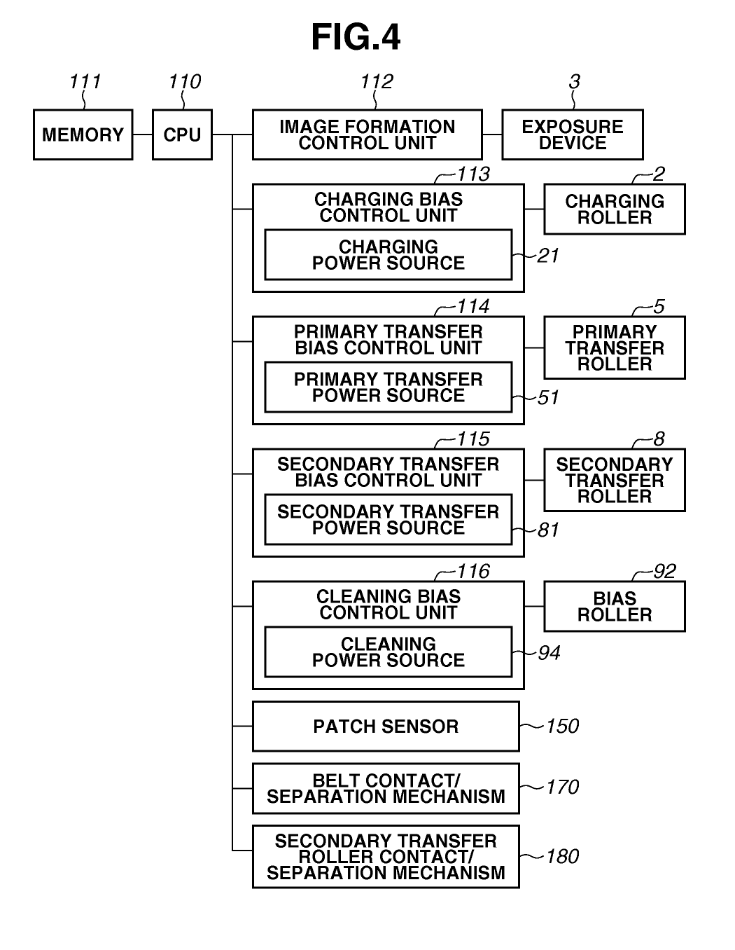

The charging roller 2 is a contact charging member that evenly charges a circumferential surface of the photosensitive drum 1 by contacting the surface of the photosensitive drum 1. The charging roller 2 is a conductive roller including an elastic layer formed around a core metal (a core member). The charging roller 2 is rotatably held by bearing members, and is also urged toward the photosensitive drum 1 by pressing springs as urging units at both ends in a longitudinal direction thereof (a direction along a rotational axis). With this urging, the charging roller 2 is brought into pressure contact with the surface of the photosensitive drum 1 with a predetermined pressing force, and is rotated by being driven according to the rotation of the photosensitive drum 1. A charging bias (a charging voltage) with a predetermined condition is applied from a charging power source 21 (refer to FIG. 4) as a bias application unit to the core metal of the charging roller 2. With this configuration, the circumferential surface of the rotating photosensitive drum 1 is charged so as to have a predetermined potential of a predetermined polarity (the negative polarity in the present exemplary embodiment). In the present exemplary embodiment, the charging bias is an oscillation voltage generated by superimposing a direct-current voltage (Vdc) and an alternating-current voltage (Vac). More specifically, the charging bias is an oscillation voltage generated by superimposing a direct-current voltage (a direct-current component) of −600 V, and a sinusoidal alternating-current voltage (an alternating-current component) having a frequency f of 1 kHz and a peak-to-peak voltage Vpp of 1.5 kV. With this charging bias, the circumferential surface of the photosensitive drum 1 is evenly charged to −600 V (a dark potential Vd).

### 2-3. Exposure Device

The exposure device 3 is a laser scanner device that includes a laser light source, a polygonal mirror, and the like, and is controlled to be lighted by a driving circuit according to an image signal. The exposure device 3 emits a laser beam according to an image signal for a component color of a document that corresponds to each of the image forming units S onto the photosensitive drum 1 via the polygonal mirror and the like.

### 2-4. Development Device

The development device 4 uses a two-component developer including non-magnetic toner and a magnetic carrier as a developer. In the present exemplary embodiment, the toner is toner having a negatively charged characteristic. The development device 4 includes a development container containing the developer. Further, the development device 4 includes a development sleeve as a developer bearing member disposed so as to be partially exposed from an opening portion of the developer container that is located opposing the photosensitive drum 1. The development sleeve is disposed adjacent to the surface of the photosensitive drum 1 and is rotationally driven by a driving motor (not illustrated) as a driving unit, and a predetermined development bias (a development voltage) is applied from a development power source (not illustrated) as a bias application unit to the development sleeve. With this configuration, the toner is supplied from the developer borne by the development sleeve and conveyed to a position opposing the photosensitive drum 1 (a development portion), and the electrostatic latent image on the photosensitive drum 1 is developed as the toner image. In the present exemplary embodiment, the development device 4 forms the toner image by a reversal development that causes the toner having the same polarity as the charged polarity of the photosensitive drum 1 to be attached onto an exposed portion on the photosensitive drum 1 that is exposed to reduce an absolute value of the potential thereon after being evenly charged. An external additive for increasing releasability of the toner is added to the toner.

### 2-5. Primary Transfer Roller

The primary transfer roller 5 is a conductive roller including an elastic layer formed around a core metal (a core member). The core metal is a cylindrical member made from conductive metal and having a diameter of mm. The elastic layer is a conductive foam material having a resistance value of 1.0×10⁴ to 5.0×10⁶ [Ω] and a thickness of 0.5 mm, and is formed around the core metal to cover the core metal. Further, a weight of the primary transfer roller 5 is 300 g. In the present exemplary embodiment, the primary transfer rollers 5 have equal outer diameters for all of the image forming units S.

The primary transfer roller 5 is supported by a pressing mechanism so as to be brought into contact with the photosensitive drum 1 from the back surface of the intermediate transfer belt 7 to cause the toner image to be transferred from the photosensitive drum 1 onto the intermediate transfer belt 7 by an electric action and a pressing force. In the present exemplary embodiment, the primary transfer roller 5 is vertically upwardly pressed at both ends in a longitudinal direction thereof (a direction along a rotational axis) by pressing springs as urging units.

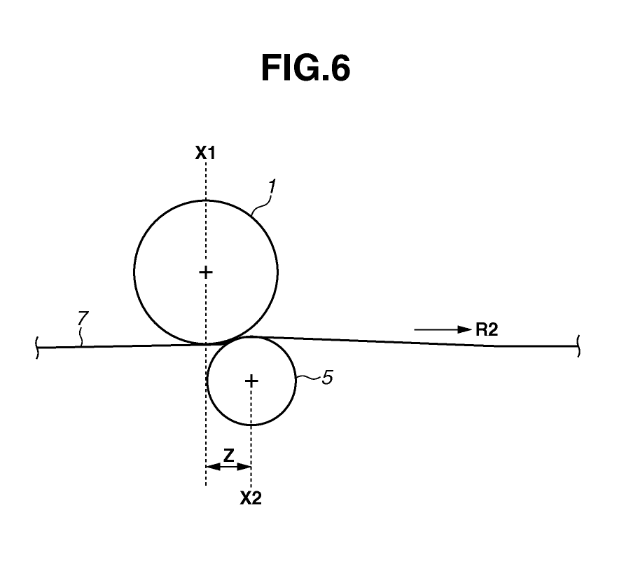

The primary transfer roller 5 is shifted toward a downstream side in the conveyance direction of the intermediate transfer belt 7 with respect to a vertical direction passing through a rotational center of the photosensitive drum 1. In the present exemplary embodiment, the primary transfer rollers 5Y, 5M, and 5C of the first, second, and third image forming units SY, SM, and SC each are shifted by a shift amount of 2.5 mm, and the primary transfer roller 5K of the fourth image forming unit SK is shifted by a shift amount of 4.5 mm. Now, as illustrated in FIG. 6, assume that X1 represents a straight line passing through the rotational center of the photosensitive drum 1 and perpendicularly intersecting the intermediate transfer belt 7 from the photosensitive drum 1 on an upstream side in the conveyance direction of the intermediate transfer belt 7. Further, assume that X2 represents a straight line passing through a rotational center of the primary transfer roller 5 and extending in parallel with the straight line X1. In this case, in the present exemplary embodiment, a shift amount Z of the primary transfer roller 5 from the photosensitive drum 1 can be represented by a shift amount of the straight line X2 from the straight line X1.

The pressing force of the primary transfer roller 5 can be measured with use of a pressure measurement tool. For example, the pressing force of the primary transfer roller 5 is measured by preparing a pseudo metallic counter roller having an equal diameter to the photosensitive drum 1 and divided into five pieces in the direction along the rotational axis, and detecting a pressure applied to the metallic counter roller with use of a load cell. This measurement system can be set inside the apparatus main body of the image forming apparatus 100, and can measure the pressure actually applied form the primary transfer roller 5 to the photosensitive drum 1. Further, this measurement system can measure a pressure distribution in the longitudinal direction of the primary transfer roller 5 due to the use of the metallic counter roller divided into the five pieces. In the present exemplary embodiment, the pressing force of the primary transfer roller 5 is set to 400 gf to 2000 gf as a total pressure for verification that will be described in detail below.

In the case where the image forming apparatus 100 uses the photosensitive drums 1 having different diameters, a difference may be made in the transferability when the toner images formed on the photosensitive drums 1 are transferred onto the intermediate transfer belt 7, if the primary transfer rollers 5 disposed to oppose the photosensitive drums 1 are set under same conditions. Examples of the conditions of the primary transfer roller 5 include the resistance and the outer diameter of the primary transfer roller 5, the position where the primary transfer roller 5 is in contact with the photosensitive drum 1, and the like. The reason therefor is considered to be as follows. At the primary transfer portion T1, a slight electric discharge occurs as the surface of the intermediate transfer belt 7 approaches the photosensitive drum 1 and is sandwiched by the photosensitive drum 1 and the primary transfer roller 5, and then moves away therefrom after that. The primary transfer portion T1 is subjected to this electric discharge in a different state among the photosensitive drums 1 having the different diameters, whereby a difference may be made in the transferability. Therefore, in the case where the photosensitive drums 1 have the different diameters, according to the present exemplary embodiment, similar transferability is established at each of the image forming units S by disposing the primary transfer roller 5 at a position according to each of the photosensitive drums 1 by, for example, adjusting the position of the primary transfer roller 5 opposing the photosensitive drum 1 so as to adjust the above-described slight electric discharge.

In the present exemplary embodiment, the image forming apparatus 100 can carry out a full color mode (a first image forming mode) and a black monochrome mode (a second image forming mode or a monochrome image forming mode) as a plurality of image forming modes, each of which uses a different number of image forming units S to form the toner image. In the full color mode, the first, second, third, and fourth image forming units SY, SM, SC, and SK form the toner images, by which the image forming apparatus 100 can form a full color image. In the black monochrome mode, only the fourth image forming unit SK forms the toner image as a predetermined image forming unit among the first, second, third, and fourth image forming units SY, SM, SC, and SK, by which the image forming apparatus 100 can form an image of the black color. Then, the image forming apparatus 100 includes a belt contact/separation mechanism 170 (refer to FIG. 4), which enables the unused photosensitive drums 1Y, 1M, and 1C of the image forming units SY, SM, and SC and the intermediate transfer belt 7 to be separated from each other in the black monochrome mode.

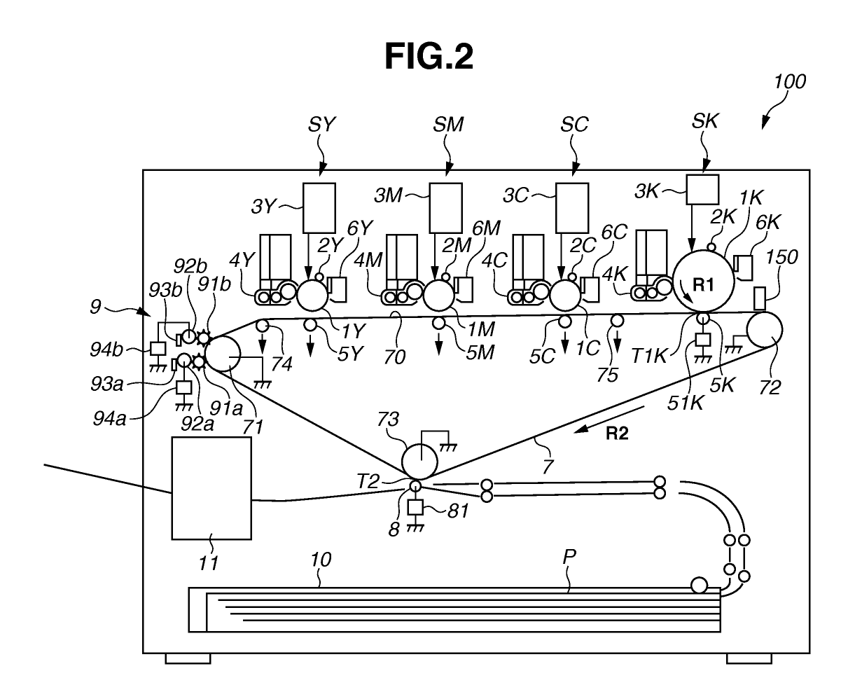

In the present exemplary embodiment, the primary transfer plane 70 is displaced by vertical movements of the push-up rollers 74 and 75 and the primary transfer rollers 5Y, 5M, and 5C of the first, second, and third image forming units SY, SM, and SC, as illustrated in FIG. 2. In the full color mode, the primary transfer plane 70 is formed by the push-up rollers 74 and 75 and the tension roller 72. In the black monochrome mode, the primary transfer plane 70 is formed by the push-up roller 75 and the tension roller 72 located downstream in the conveyance direction of the intermediate transfer belt 7. With this configuration, in the full color mode, the photosensitive drums 1Y, 1M, 1C, and 1K of the first, second, third, and fourth image forming units SY, SM, SC, and SK, and the intermediate transfer belt 7 are brought into contact with each other. On the other hand, in the black monochrome mode, the photosensitive drums 1Y, 1M, and 1C of the first, second, and third image forming units SY, SM, and SC, and the intermediate transfer belt 7 are separated from each other. In this manner, the image forming apparatus 100 is configured to be able to selectively switch the black monochrome mode and the full color mode. The belt contact/separation mechanism 170 includes a support member or support members of the push-up rollers 74 and 75 and the primary transfer rollers 5Y, 5M and 5C of the first, second, and third image forming units SY, SM, and SC, a switching unit or switching units for moving these rollers via the support member(s), and the like. In the present exemplary embodiment, a solenoid is used as this switching unit. The switching unit(s) selectively move(s) the above-described respective rollers vertically, i.e., between the first position where the rollers cause the intermediate transfer belt 7 to be displaced further closer to the photosensitive drum 1, and the second position where the rollers cause the intermediate transfer belt 7 to be further separated from the photosensitive drum 1. In the present exemplary embodiment, the image forming apparatus 100 is configured to be able to separate the unused photosensitive drums 1Y, 1M, and 1C of the first, second, and third image forming units SY, SM, and SC from the intermediate transfer belt 7 in the black monochrome mode, thereby attempting to extend lifetimes of these photosensitive drums 1Y, 1M, and 1C. Further, the image forming apparatus 100 adopts the large diameter for the photosensitive drum 1K of the fourth image forming unit SK for the black color, which is generally highly frequently used in most cases, thereby extending a lifetime of this photosensitive drum 1K. The image forming unit S using the photosensitive drum 1 large in diameter does not necessarily have to be the image forming unit SK for the black color, and does not necessarily have to be the image forming unit S located most downstream in the conveyance direction of the intermediate transfer belt 7. Further, the image forming unit S using the photosensitive drum 1 large in diameter does not necessarily have to be only a single image forming unit S, such as the image forming unit SK for the black color. A plurality of image forming units S may use the photosensitive drums 1 having larger outer diameters than the other image forming units S (the outer diameters of the photosensitive drums 1 may be equal or different among this plurality of image forming units S).

In the present exemplary embodiment, the primary transfer bias is determined by known Active Transfer Voltage Control (ATVC) (refer to Japanese Patent Application Laid-Open No. 2-123385). More specifically, a desired constant-current voltage is applied to the primary transfer roller 5 when the image forming apparatus 100 does not form an image, and a voltage value at this time is held. Then, a constant voltage according to this voltage value is applied to the primary transfer roller 5 as the primary transfer voltage at the time of the primary transfer when the image forming apparatus 100 forms an image. An optimum current is found out in advance as a primary transfer current at the time of the application of the constant-current voltage when the image forming apparatus 100 does not form an image, and a transfer electric field at the primary transfer portion T1 when this current is set as a target current is determined.

### 2-6. Intermediate Transfer Belt

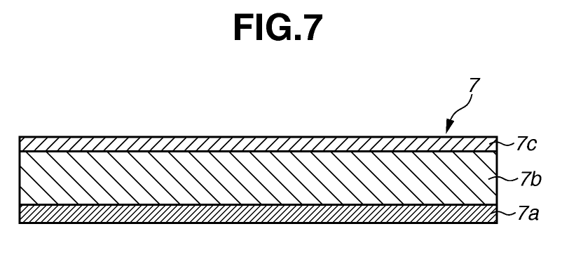

In the present exemplary embodiment, a belt including a plurality of layers and including an elastic layer (hereinafter also referred to as an “elastic intermediate transfer belt”) is used as the intermediate transfer belt 7. FIG. 7 is a schematic cross-sectional view illustrating an example layer structure of the elastic intermediate transfer belt 7. In the present exemplary embodiment, the elastic intermediate transfer belt 7 has a three-layered structure including a base layer (a resin layer) 7a, an elastic layer 7b, and a front layer 7c. The elastic intermediate transfer belt 7 according to the present exemplary embodiment has a surface resistivity of 10¹²Ω/□ and a volume resistivity of 10¹² Ω·cm as the three layers to maintain imageability. The resistivity was measured with use of Hiresta UP MCP-HT450 with a UR probe, which was a high resistivity meter available from Mitsubishi Chemical Analytech, Co., Ltd., under an applied voltage of 1000 V and an applied time period of 10 seconds as measurement conditions. Further, desirable film thicknesses of the respective layers of the elastic intermediate transfer belt 7 are approximately 50 to 100 μm for the base layer 7a, approximately 200 to 300 μm for the elastic layer 7b, and approximately 2 to 20 μm for the front layer 7c. In the present exemplary embodiment, the base layer 7a, the elastic layer 7b, and the front layer 7c have film thicknesses of 85 μm, 260 μm, and 2 μm, respectively. Further, a desirable surface hardness of the elastic intermediate transfer belt 7 as the three layers is approximately 40 to 90 degrees in the International Rubber Hardness Degrees (IRHD) scale. In the present exemplary embodiment, the surface hardness of the elastic intermediate transfer belt 7 is 73±3 degrees.

The base layer 7a and the elastic layer 7b may be made of any materials that can meet the above-described characteristics. Representative examples thereof are as follows. The base layer (the resin layer) 7a can be made of a resin material such as polycarbonate, a fluorine-based resin (ethylene-tetrafluoroethylene (ETFE) or polyvinylidene difluoride (PVDF)), a polyamide resin, and a polyimide resin that have a Young's modulus of 5.0×10² to 5.0×10³ MPa (compliant with Japanese Industrial Standards (JIS) K7127). Further, the elastic layer 7b can be made of an elastic material (an elastic material rubber or an elastomer) such as a butyl rubber, a fluorine-based rubber, a chloroprene (CR) rubber, ethylene propylene diene monomer (EPDM), and a urethane rubber that have a Young's modulus of 0.1 to 1.0×10² MPa. Further, the material of the front layer 7c is not especially limited, but is desirably a material that can reduce a force of attaching the toner onto the surface of the intermediate transfer belt 7 to improve secondary transferability. Examples thereof include a resin material such as a fluorine-based resin and a fluorine compound, a urethane-based resin with fluorine-based resin particles distributed therein, and an elastic material that have a Young's modulus of 1.0×10² to 5.0×10³ MPa. However, none of the base layer 7a, the elastic layer 7b, and the front layer 7c is limited to the above-described materials. In this manner, in the present exemplary embodiment, the intermediate transfer member includes at least a plurality of layers, and the layer on the surface side that bears the toner image has a lower hardness than the lowermost layer on the surface side that does not bear the toner image.

In the present exemplary embodiment, the above-described elastic intermediate transfer belt is used as the intermediate transfer belt 7. However, a single-layered belt such as a resin belt may be used as the intermediate transfer belt 7.

### 2-7. Secondary Transfer Roller

The secondary transfer roller 8 is a conductive roller including an elastic layer made of an ion conductive foamed rubber (a nitrile butadiene rubber (NBR)) that is formed around a core metal (a core member). This secondary transfer roller 8 has an outer diameter of 24 mm and a roller surface roughness of Rz=6.0 to 12.0 (μm). Further, this secondary transfer roller 8 has a resistance value of 1.0×10⁵ to 1.0×10⁸Ω measured under a normal temperature and normal humidity (N/N) environment (a temperature of 23° C. and a relative humidity (RH) of 50%) and an applied voltage of 2 kV.

In the present exemplary embodiment, the image forming apparatus 100 includes a secondary transfer roller contact/separation mechanism 180 (refer to FIG. 4), which displaces the secondary transfer roller 8 into contact with the intermediate transfer belt 7, and separates the secondary transfer roller 8 from the intermediate transfer belt 7. With this mechanism, the secondary transfer roller 8 is configured to be able to be selectively switched between an operable state in which the secondary transfer roller 8 is in contact with the intermediate transfer belt 7 to be rotated according to the rotation of the intermediate transfer belt 7, and an inoperable state in which the secondary transfer roller 8 is separated from the intermediate transfer belt 7. The secondary transfer roller contact/separation mechanism 180 includes a support member of the secondary transfer roller 8, a switching unit for moving the secondary transfer roller 8 via this support member, and the like. In the present exemplary embodiment, a solenoid is used as this switching unit. The switching unit selectively moves the secondary transfer roller 8 vertically, i.e., between a first position where the secondary transfer roller 8 is in contact with the intermediate transfer belt 7, and a second position where the secondary transfer roller 8 is separated from the intermediate transfer belt 7. In the present exemplary embodiment, the secondary transfer roller 8 is separated from the intermediate transfer belt 7 when a patch, which is an adjustment toner image formed on the intermediate transfer belt 7 at the time of an image density adjustment or the like, passes through the secondary transfer portion T2. The image forming apparatus 100 is configured in such a manner that this patch is detected by a patch sensor 150 as a detection unit.

### 2-8. Belt Cleaning Device (Electrostatic Fur Cleaning)

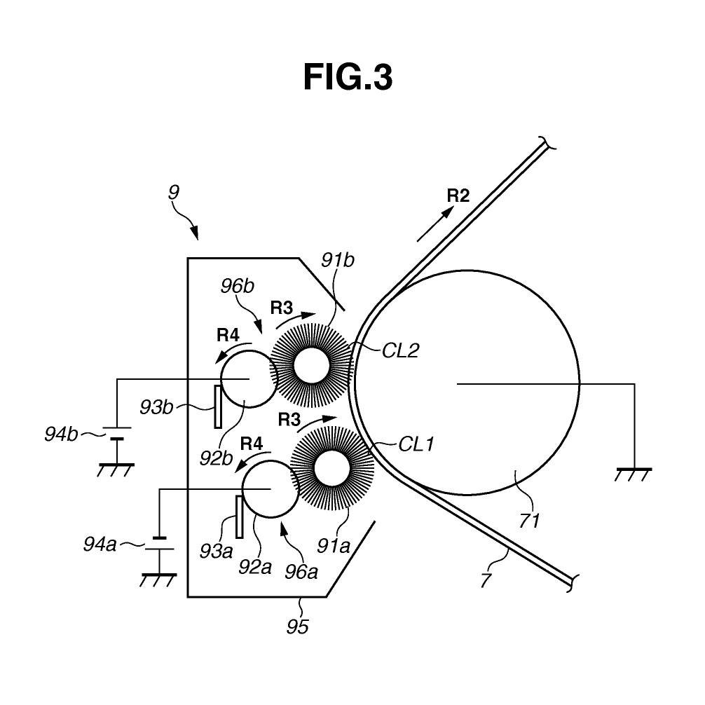

In the present exemplary embodiment, the belt cleaning device 9 based on the electrostatic cleaning method that electrostatically removes the toner is used as the intermediate transfer member cleaning unit. FIG. 3 is a schematic cross-sectional view illustrating the belt cleaning device 9 according to the present exemplary embodiment. The belt cleaning device 9 is disposed upstream of the primary transfer portion T1 (more specifically, the primary transfer portion T1Y located most upstream) and downstream of the secondary transfer portion T2 in the conveyance direction of the intermediate transfer belt 7.

The belt cleaning device 9 includes a housing 95 disposed close to the intermediate transfer belt 7. The belt cleaning device 9 includes an upstream fur brush 91a as a first collection member disposed upstream in the conveyance direction of the intermediate transfer belt 7, and a downstream fur brush 91b as a second collection member disposed downstream in the conveyance direction of the intermediate transfer belt 7, inside the housing 95. The upstream fur brush 91a and the downstream fur brush 91b form a first electrostatic cleaning portion CL1 and a second electrostatic cleaning portion CL2 that collect the toner from the intermediate transfer belt 7 by contacting the intermediate transfer belt 7 at positions opposing the driving roller 71 via the intermediate transfer belt 7, respectively. Further, the belt cleaning device 9 includes an upstream bias roller 92a as a first voltage application member in contact with the upstream fur brush 91a, and a downstream bias roller 92b as a second voltage application member in contact with the downstream fur brush 91b, inside the housing 95. Further, the belt cleaning device 9 includes an upstream blade 93a as a first removal member in contact with the upstream bias roller 92a, and a downstream blade 93b as a second removal member in contact with the downstream bias roller 92b, inside the housing 95.

The upstream and downstream fur brushes 91a and 91b each are a conductive fur brush formed by providing carbon-dispersed nylon fibers having a bristle resistance value of 0.3 M (Ω/cm) and a fiber thickness of 6 denier onto a metallic roller (a core member) at a bristle density of five hundred thousand fibers/inch². Further, the upstream and downstream bias rollers 92a and 92b each are embodied by an aluminum metallic roller. Further, the upstream and downstream blades 93a and 93b each are embodied by a plate-shaped member made of a urethane rubber. In this manner, in the present exemplary embodiment, an upstream cleaning member 96a as a first cleaning member includes the upstream fur brush (cleaning brush) 91a, the upstream bias roller 92a, and the upstream blade 93a. Further, in the present exemplary embodiment, a downstream cleaning member 96b as a second cleaning member includes the downstream fur brush (cleaning brush) 91b, the downstream bias roller 92b, and the downstream blade 93b. Then, these upstream and downstream cleaning members 96a and 96b are disposed in parallel along the conveyance direction of the intermediate transfer belt 7.

The upstream and downstream fur brushes 91a and 91b are disposed so as to be brought into slidable contact with the intermediate transfer belt 7 while maintaining inroad amounts of approximately 1.0 mm into the intermediate transfer belt 7. The upstream and downstream fur brushes 91a and 91b are rotationally driven by driving motors (not illustrated) as driving units in directions indicated by arrows R3 in FIG. 3 at speeds (circumferential speeds) of 50 mm/second. These movement directions indicated by the arrows R3 are reverse directions of the movement direction of the intermediate transfer belt 7 at the first and second electrostatic cleaning portions CL1 and CL2. The upstream and downstream bias rollers 92a and 92b are disposed so as to maintain inroad amounts of approximately 1.0 mm into the upstream and downstream fur brushes 91a and 91b, respectively. The upstream and downstream bias rollers 92a and 92b are rotationally driven by driving motors (not illustrated) as driving units in directions indicated by arrows R4 in FIG. 3 at similar speeds (circumferential speeds) to the upstream and downstream fur brushes 91a and 91b, respectively. These movement directions indicated by the arrows R4 are reverse directions of the movement directions of the upstream and downstream fur brushes 91a and 91b at portions where the upstream and downstream bias rollers 91a and 91b are in contact with the upstream and downstream fur brushes 91a and 91b, respectively. The upstream and downstream blades 93a and 93b are disposed so as to maintain inroad amounts of approximately 1.0 mm into the upstream and downstream bias rollers 92a and 92b, respectively. The upstream and downstream blades 93a and 93b are in contact (counter abutment) with the upstream and downstream bias rollers 92a and 92b in such a manner that free ends thereof are located upstream of fixed ends thereof in the rotational directions of the upstream and downstream bias rollers 92a and 92b, respectively.

A direct-current voltage negative in polarity is applied as a cleaning bias (a cleaning voltage) from a first cleaning power source 94a as a voltage application unit to the upstream bias roller 92a. Further, a direct-current voltage positive in polarity is applied as a cleaning bias from a second cleaning power source 94b as a voltage application unit to the downstream bias roller 92b. The first and second cleaning power sources 94a and 94b apply the cleaning biases controlled to be constant current so as to cope with the potentials on the intermediate transfer belt 7 and the upstream and downstream fur brushes 91a and 91b under various conditions. In the present exemplary embodiment, as a current value of each of the cleaning biases, a suitable current is predetermined for each of cleaning performances at the time of the normal image formation and at the time of cleaning for the patch, and the cleaning bias is applied under the constant current control so as to achieve a flow of this current.

An operation of cleaning the transfer residual toner on the intermediate transfer belt 7 will be described now. The application of the cleaning bias negative in polarity (−) to the upstream bias roller 92a leads to generation of a potential difference between the intermediate transfer belt 7 and the upstream fur brush 91a. With this difference, toner charged positively in polarity (+) in the transfer residual toner on the intermediate transfer belt 7 is attracted and transferred onto the upstream fur brush 91a side. This toner attracted and transferred onto the upstream fur brush 91a is transferred from the upstream fur brush 91a to the upstream bias roller 92a due to a potential difference between the upstream fur brush 91a and the upstream bias roller 92a. Then, this toner transferred onto the upstream bias roller 92a is swept down from the upstream bias roller 92a by the upstream blade 93a to be collected into a collected toner container formed in the housing 95.

Even after the transfer residual toner on the intermediate transfer belt 7 is cleaned by the upstream cleaning member 96a, non-polar toner and toner charged negatively in polarity (−) remain on the intermediate transfer belt 7. These kinds of toner are charged negatively in polarity (−) by the cleaning bias negative in polarity that is applied to the upstream fur brush 91a. It is considered that the toner is charged by a charge injection or an electric discharge.

Then, the application of the cleaning bias positive in polarity (+) to the downstream bias roller 92b leads to generation of a potential difference between the intermediate transfer belt 7 and the downstream fur brush 91b, thereby enabling the remaining toner to be attracted and transferred onto the downstream fur brush 91b. The toner attracted and transferred onto the downstream fur brush 91b is transferred from the downstream fur brush 91b to the downstream bias roller 92b due to a potential difference between the downstream fur brush 91b and the downstream bias roller 92b. Then, this toner transferred onto the downstream bias roller 92b is swept down from the downstream bias roller 92b by the downstream blade 93b. In this manner, the transfer residual toner remaining on the intermediate transfer belt 7 can be sufficiently removed and collected.

Next, an operation performed when the patch is cleaned will be described. When the patch passes through the secondary transfer portion T2, the secondary transfer roller 8 is separated from the intermediate transfer belt 7. The toner of the patch is not transferred to the transfer medium P, and is conveyed to the first and second electrostatic cleaning portions CL1 and CL2. Therefore, most of the toner of the patch is charged negatively in polarity (−). This toner of the patch that is charged negatively in polarity (−) is little collected by the upstream cleaning member 96a to which the cleaning bias negative in polarity (−) is applied, and is collected by the downstream cleaning member 96b to which the cleaning bias positive in polarity (+) is applied.

In the present exemplary embodiment, during execution of the adjustment operation with use of the patch, the secondary transfer roller 8 is separated from the intermediate transfer belt 7 before the patch transferred onto the intermediate transfer belt 7 reaches the secondary transfer portion T2. This separation prevents the toner of the patch from being transferred to the secondary transfer roller 8. However, the present invention is not limited to this configuration. In a case of a configuration that does not allow the secondary transfer roller 8 to be separated from the intermediate transfer belt 7, the following method can be employed. When the toner of the patch passes through the secondary transfer portion T2, a secondary transfer bias having a negative polarity, which is an opposite polarity from the normal image formation, is applied to the secondary transfer roller 8. This application prevents the toner of the patch from being transferred to the secondary transfer roller 8 with the action of an electric field generated at the secondary transfer portion T2.

### 3. Control Configuration

FIG. 4 illustrates an overview of a control configuration of main portions of the image forming apparatus 100 according to the present exemplary embodiment. The image forming apparatus 100 includes a central processing unit (CPU) 110 as a control unit that comprehensively controls the image forming apparatus 100, and a memory 111 as a storage unit such as a read only memory (ROM) and a random access memory (RAM). The RAM stores a result of the detection by the sensor, a result of calculation, and the like. The ROM stores a control program, a predetermined data table, and the like. The CPU 110 controls an image formation control unit 112, a charging bias control unit 113, a primary transfer bias control unit 114, a secondary transfer bias control unit 115, a cleaning bias control unit 116, and the like in terms of a relationship with the present exemplary embodiment. Further, the CPU 110 controls the patch sensor 150, the belt contact/separation mechanism 170, the secondary transfer roller contact/separation mechanism 180, and the like.

The image formation control unit 112 controls exposure timing of the exposure device 3 and the like. The charging bias control unit 113 can output a voltage controlled to be a constant voltage from the charging power source 21 to the charging roller 2. More specifically, the charging bias control unit 113 includes a voltage detection unit that detects an output voltage value, and can perform the constant voltage control according to a setting voltage value under control by the CPU 110. Further, the primary transfer bias control unit 114 can output a voltage controlled to be the constant current and a voltage controlled to be the constant voltage from the primary transfer power source 51 to the primary transfer roller 5. More specifically, the primary transfer bias control unit 114 includes a current detection unit that detects a current value flowing when the voltage is applied to the primary transfer roller 5, and a voltage detection unit that detects an output voltage value. Then, the primary transfer bias control unit 114 can perform the constant current control and the constant voltage control on the bias to be applied to the primary transfer roller 5 by feeding back results of the detection to the CPU 110. The secondary transfer bias control unit 115 also operates similarly to the primary transfer bias control unit 114. Further, the cleaning bias control unit 116 can output a voltage controlled to be the constant current from the cleaning power source 94 to the bias roller 92. More specifically, the cleaning bias control unit 116 includes a current detection unit that detects a current value flowing when the voltage is applied to the bias roller 92. Then, the cleaning bias control unit 116 can perform the constant current control on the bias to be applied to the bias roller 92 by feeding back a result of the detection to the CPU 110.

### 4. Pressing Force of Primary Transfer Roller

Next, a setting of the pressing force of the primary transfer roller 5 will be described in further detail. In the following description, the first, second, third, and fourth image forming units SY, SM, SC, and SK may be referred to as simply a “Y station”, an “M station”, a “C station”, and a “K station”, respectively.

There is a large difference in a charge amount of the toner between the transfer residual toner after the transfer electric field is applied thereto at the secondary transfer portion T2, and the toner of the patch, which is the adjustment toner image. Examples of the patch include the density patch for acquiring the desired image density, a toner replenishment control patch for controlling a toner density in the developer, the registration patch for correcting the color misregistration. The transfer residual toner is toner remaining on the intermediate transfer belt 7 without being transferred at the secondary transfer portion T2, and is toner having an extremely low negative charge with the charge amount reduced to zero or almost zero or having a positive charge under the influence of the electric field at the secondary transfer portion T2. On the other hand, the present exemplary embodiment employs a configuration that omits a cleaning member for the secondary transfer roller 8, and therefore separates the secondary transfer roller 8 from the intermediate transfer belt 7 when the patch passes through the secondary transfer portion T2. Therefore, the toner of the patch is supplied to the electrostatic cleaning portions CL1 and CL2 without receiving the influence of the electric field at the secondary transfer portion T2. Therefore, the charge amount of the toner of the patch is negative in polarity, unlike the secondary transfer residual toner, and a total amount thereof is also significantly larger than the transfer residual toner.

When the toner is supplied to the electrostatic cleaning portions CL1 and CL2 while carrying a large charge amount per unit time, like the toner of the patch, the voltage applied to each of the fur brushes 91a and 91b is changed due to the charge of the toner entering from the outside. Therefore, a change occurs in the attraction force between the intermediate transfer belt 7 and the fur brushes 91a and 91b, which leads to a change in the speed of the intermediate transfer belt 7. This change in the speed easily travels via the intermediate transfer belt 7, and is easily transmitted to the members located downstream of the electrostatic cleaning portions CL1 and CL2, in particular, the image forming unit S located directly downstream thereof. This image forming unit S is the Y station in the full color mode, and the K station in the black monochrome mode.

In the present exemplary embodiment, the outer diameters of the photosensitive drums 1 at the Y station and the K station are set to φ30 mm and φ84 mm, respectively. In the case where the photosensitive drums 1 have the different outer diameters among them in this manner while the primary transfer rollers 5 have the equal outer diameters among them, the size of the nip is larger at the primary transfer portion T1 of the station corresponding to the photosensitive drum 1 having the large outer diameter than the other stations. In other words, when equal pressures are applied to the primary transfer portions T1 at the Y station and the K station, a pressure per unit area is lower at the station corresponding to the photosensitive drum 1 having the large outer diameter, whereby this station is susceptible to an influence of the change in the speed of the intermediate transfer belt 7. If this change in the speed is transmitted to the primary transfer portion T1, this transmission causes a micro vibration, a slip, and the like within the nip of the primary transfer portion T1, thereby causing the toner image to scatter. As a result, a density unevenness may be visualized in an image (an uneven image). Further, the vibration may be transmitted from the primary transfer portion T1 to the photosensitive drum 1, and further transmitted to the development unit and the charging unit, which may further disturb the toner image.

Further, the elastic intermediate transfer belt using the elastic layer may be used as the intermediate transfer member, like the present exemplary embodiment, for example, to solve a partial printing void in which the toner partially fails to be transferred and remains on the photosensitive member 1 due to a high pressure at the time of the transfer. Especially, the elastic intermediate transfer belt includes the elastic layer, which facilitates occurrence of the above-described micro slip between the intermediate transfer belt 7 and the photosensitive drum 1 at the primary transfer portion T1.

Therefore, in the present exemplary embodiment, the pressing force of the primary transfer roller 5K at the K station, which is used in the black monochrome mode, is increased within an optimum range. This increase can reduce the above-described transmission of the vibration of the intermediate transfer belt 7.

In this case, if the pressing forces are also increased in a similar manner at the primary transfer rollers 5Y, 5M, and 5C of the Y, M, and C stations including the photosensitive drums 1 small in diameter, this results in an excessive increase in the pressure applied to the toner. Then, the toner is transferred onto the recording medium P at the secondary transfer portion T2 with toner particles therein in an agglomerated state, resulting in formation of a coarse image in which the toner remains on the intermediate transfer belt 7 side without being completely transferred onto the transfer medium P especially when an image of a secondary or higher order color is transferred. Therefore, this increase is not favorable.

In the present exemplary embodiment, the following verification has been conducted. The pressing force (the total pressure) of the primary transfer roller 5 was changed within a range of 400 to 2000 gf at each of the Y, M, C, and K stations, and whether the uneven image was formed (the unevenness occurred in the image density) was checked in each case. At this time, solid and halftone images of the respective colors, and solid and halftone images of a secondary color regarding the yellow, magenta, and cyan colors were output as images for evaluation. Further, it was checked whether the coarse image, which would be formed by the change in the total pressure of the primary transfer roller 5, was formed. At any of image output timings, these phenomena were checked by evaluating a first output immediately after the cleaning for the patch, which was a moment when the uneven image was highly likely formed. The details of the respective images will be described below. In the present example, the patch is formed on a sheet-to-sheet space (a region corresponding to an interval between a transfer medium P and a transfer medium P) when images are successively formed on a plurality of transfer media P.

Regarding the image density, the exposure was set so as to output a density within a range of 1.6±0.1 measured with use of 530 Spectrodensitometer available from X-Rite, Incorporated. Further, the comparison was conducted while setting the primary transfer current to a transfer current capable of achieving a most efficient transfer for each case.

A table 1 presents a result of the verification. In the table 1, “x” indicates that the uneven image or the coarse image was formed more than an allowable degree, and “∘” indicates that the uneven image or the coarse image was not formed. When the total pressure of the primary transfer roller 5 is 400 gf, the coarse image cannot achieve a desired density and is not worthy of being compared, whereby a dash mark is placed in cells corresponding to this case.

TABLE 1

| | | | | | | | | | BLACK | |
|---|---|---|---|---|---|---|---|---|---|---|
| | | | | | | | | | MONOCHROME | |
| PRIMARY | FULL COLOR MODE | | | | | | | | MODE | |
| TRANSFER | Y | | M | | C | | K | | K | |
| TOTAL | STATION | | STATION | | STATION | | STATION | | STATION | |
| PRESSURE | UNEVEN | COARSE | UNEVEN | COARSE | UNEVEN | COARSE | UNEVEN | COARSE | UNEVEN | COARSE |
| (gf) | IMAGE | IMAGE | IMAGE | IMAGE | IMAGE | IMAGE | IMAGE | IMAGE | IMAGE | IMAGE |
| 400 | x | — | x | — | x | - | x | — | x | — |
| 600 | ∘ | ∘ | ∘ | ∘ | ∘ | ∘ | ∘ | ∘ | x | ∘ |
| 800 | ∘ | ∘ | ∘ | ∘ | ∘ | ∘ | ∘ | ∘ | x | ∘ |
| 1000 | ∘ | x | ∘ | x | ∘ | x | ∘ | ∘ | x | ∘ |
| 1200 | ∘ | x | ∘ | x | ∘ | x | ∘ | ∘ | ∘ | ∘ |
| 1400 | ∘ | x | ∘ | x | ∘ | x | ∘ | ∘ | ∘ | ∘ |
| 1600 | ∘ | x | ∘ | x | ∘ | x | ∘ | ∘ | ∘ | ∘ |
| 1800 | ∘ | x | ∘ | x | ∘ | x | ∘ | x | ∘ | x |
| 2000 | ∘ | x | ∘ | x | ∘ | x | ∘ | x | ∘ | x |

The table 1 reveals that an optimum total pressure of the primary transfer roller 5 in the full color mode is 600 to 800 gf for the Y, M, and C stations, and 600 to 1600 gf for the K station. On the other hand, the table 1 reveals that an optimum total pressure of the primary transfer roller 5 in the black monochrome mode is 1200 to 1600 gf for the K station.

First, the formation of the uneven image is caused by the above-described change in the speed of the intermediate transfer belt 7. In the full color mode, the uneven image was formed when the total pressure of the primary transfer roller 5 was 400 gf with respect to each of the Y, M, C, and K stations. On the other hand, in the black monochrome mode, the uneven image was formed when the total pressure of the primary transfer roller 5 was 1000 gf or lower, whereby the result reveals that the uneven image is more easily formed in the black monochrome mode. In the black monochrome mode, the intermediate transfer belt 7 is separated from the photosensitive drums 1Y, 1M, and 1C at the Y, M, and C stations, whereby the intermediate transfer belt 7 is sandwiched by only the single K station. As a result, the image formation is more susceptible to the influence of the change in the speed of the intermediate transfer belt 7 in the black monochrome mode than in the full color mode in which the change in the speed of the intermediate transfer belt 7 is absorbed by the four image forming units S. This is considered to be a reason for the above-described result.

The uneven image was formed when the total pressure was 450 gf with respect to the Y station, and the uneven image was formed when the total pressure was 400 gf with respect to each of the M and C stations, although these cases are omitted in the table 1. This result reveals that the change in the speed of the intermediate transfer belt 7 is easily transmitted to the image forming unit S located directly downstream of the electrostatic cleaning portions CL1 and CL2.

Next, the coarse image is deteriorated by the increase in the pressing force of the primary transfer roller 5. The reason therefor is considered to be as follows. The pressure is applied to the toner at the nip portion of the primary transfer portion T1, and the toner particles are cohered together, increasing an agglomeration degree. Further, the toner is attached to the intermediate transfer belt 7 with a further stronger sticking force, and therefore becomes more difficult to be separated from the intermediate transfer belt 7 at the secondary transfer portion T2. Therefore, although the toner is supposed to be applied by a large amount at the secondary transfer portion T2, transfer efficiency is reduced at the secondary transfer portion T2, which makes it impossible to transfer the toner onto the transfer medium P with the action of the secondary transfer electric field especially when the toner has to be secondarily transferred onto a highly rough recording medium P such as rough paper. This reduction in the transfer efficiency is noticeable especially when the solid image of the secondary color is secondarily transferred, whereby the coarse image is deteriorated when the total pressure is 1000 gf or higher with respect to each of the Y, M, and C stations. Regarding the K station, the black solid image is an image formed from a single color with a small toner application amount. In addition thereto, the K station is the image forming unit S located most downstream, so that the toner does not receive the pressure at the primary transfer portion T1 after passing through the K station. Therefore, the coarse image was not formed even when the total pressure was 1600 gf. Further, the solid image of the secondary color was not output as the coarse image even when the total pressure was 1600 gf at the K station, as long as the total pressure was 800 gf or lower at each of the Y, M, and C stations. Therefore, an upper limit on the total pressure at the K station was set to 1600 gf.

On the other hand, a similar experiment to the above-described experiment was conducted on the configuration including the cleaning member for the secondary transfer roller 8 and configured to collect the patch from the secondary transfer roller 8 after attaching the toner to the secondary transfer roller 8, as a comparative example 1. A table 2 presents a result of this experiment in a column (a). Further, a similar experiment to the above-described experiment was conducted on the configuration employing the blade cleaning method, according to which the toner was raked by a blade, as the method for cleaning the intermediate transfer belt 7, as a comparative example 2. The table 2 presents a result of this experiment in a column (b). In the comparative example 2, the secondary transfer roller 8 is also separated from the intermediate transfer belt 7 when the patch passes through the secondary transfer portion T2. The table 2 lists results in the black monochrome mode, in which the comparative examples 1 and 2 produced different outcomes from the present exemplary embodiment.

TABLE 2

| | (a) | | (b) | |
|---|---|---|---|---|
| PRIMARY | BLACK | | BLACK | |
| TRANSFER | MONOCHROME MODE | | MONOCHROME MODE | |
| TOTAL | K STATION | | K STATION | |
| PRESSURE | UNEVEN | COARSE | UNEVEN | COARSE |
| (gf) | IMAGE | IMAGE | IMAGE | IMAGE |
| 400 | x | — | ∘ | — |
| 600 | ∘ | ∘ | ∘ | ∘ |
| 800 | ∘ | ∘ | ∘ | ∘ |
| 1000 | ∘ | ∘ | ∘ | ∘ |
| 1200 | ∘ | ∘ | ∘ | ∘ |
| 1400 | ∘ | ∘ | ∘ | ∘ |
| 1600 | ∘ | ∘ | ∘ | ∘ |
| 1800 | ∘ | x | ∘ | x |
| 2000 | ∘ | x | ∘ | x |

In the case where the patch is collected at the secondary transfer portion T2, like the comparative example 1, the patch on the intermediate transfer belt 7 has a similar toner amount, and also has an almost similar charge amount to the transfer residual toner at the time of the normal image formation, after passing through the secondary transfer portion T2. Therefore, the speed of the intermediate transfer belt 7 is only slightly changed when the toner is collected at the electrostatic cleaning portions CL1 and CL2. Therefore, the unevenness does not occur even when the total pressure is 600 gf or higher at the K station. Further, in the comparative example 2, the secondary transfer roller 8 is separated from the intermediate transfer belt 7, but the toner of the patch is substantially entirely collected at a blade cleaning portion. In this case, even the toner of the patch little affects the change in the speed of the intermediate transfer belt 7, and the unevenness does not occur even when the total pressure is 400 gf or higher at the K station.

In this manner, in the present exemplary embodiment, the image forming apparatus 100 includes the drum-shaped first photosensitive members 1Y to 1C each having a first outer diameter and configured in such a manner that the toner image is formed thereon, and the drum-shaped second photosensitive member 1K having a larger second outer diameter than the first outer diameter and configured in such a manner that the toner image is formed thereon. Further, the image forming apparatus 100 includes the rotatable intermediate transfer belt 7 made as the endless belt. The toner images are transferred from the first and second photosensitive members 1Y to 1K onto the intermediate transfer belt 7 at the respective primary transfer portions T1Y to T1K. The toner images are secondarily transferred from the intermediate transfer belt 7 onto the transfer medium P at the secondary transfer portion T2. Further, the image forming apparatus 100 includes the first primary transfer rollers 5Y to 5C, and the second primary transfer roller 5K. The first and second primary transfer rollers 5Y to 5K form the primary transfer portions T1Y to T1K by being pressed toward the first and second photosensitive members 1Y to 1K via the intermediate transfer belt 7, respectively, and transfer the toner images from the first and second photosensitive members 1Y to 1K onto the intermediate transfer belt 7 by the application of the voltages thereto, respectively. Further, the image forming apparatus 100 includes the cleaning unit 9 that electrostatically removes the toner attached to the intermediate transfer belt 7 on the upstream side of the primary transfer portions T1Y to T1K (more specifically, the primary transfer portion T1Y located most upstream) and on the downstream side of the secondary transfer portion T2 in the rotational direction of the intermediate transfer belt 7. Further, the image forming apparatus 100 can carry out the following respective modes as the image forming modes. One of the modes is the first image forming mode (the full color mode), in which the image forming apparatus 100 causes the first and second photosensitive members 1Y to 1K and the intermediate transfer belt 7 to contact each other to transfer the toner images from the first and second photosensitive members 1Y to 1K onto the intermediate transfer belt 7. Another one of the modes is the second image forming mode (the black monochrome mode), in which the image forming apparatus 100 causes the first photosensitive members 1Y to 1C of the first and second photosensitive members 1Y to 1K, and the intermediate transfer belt 7 to be separated from each other to transfer the toner image from the second photosensitive member 1K onto the intermediate transfer belt 7. Then, the pressing force applied from the second primary transfer roller 5K to the second photosensitive member 1K is stronger than the pressing forces applied from the first primary transfer rollers 5Y to 5C to the first photosensitive members 1Y to 1C. Especially, in the present exemplary embodiment, the cleaning unit 9 based on the above-described electrostatic cleaning method collects the adjustment toner image attached to the intermediate transfer belt 7 during the adjustment operation. Further, the secondary transfer roller 8 is separated from the intermediate transfer belt 7 when the adjustment toner image on the intermediate transfer belt 7 passes through the secondary transfer portion T2.

In this manner, according to the present exemplary embodiment, the primary transfer roller 5 applies an increased pressing force to the photosensitive drum 1 at the image forming unit S used in the monochrome image forming mode in the configuration including the intermediate transfer belt 7 and the photosensitive drums 1 having the different outer diameters. This arrangement can eliminate or reduce the influence of the change in the speed of the intermediate transfer belt 7 that is transmitted to the primary transfer portion T1 of this image forming unit S to stabilize the primary transfer portion T1, thereby enabling the image forming apparatus 100 to prevent or reduce occurrence of a failure such as the density unevenness.

Next, a second exemplary embodiment of the present invention will be described. A basic configuration and operation of an image forming apparatus according to the present exemplary embodiment are similar to the configuration and the operation according to the first exemplary embodiment. Therefore, components having functions or configurations similar or corresponding to the components according to the first exemplary embodiment will be identified by the same reference numerals, and detailed descriptions thereof will be omitted below.

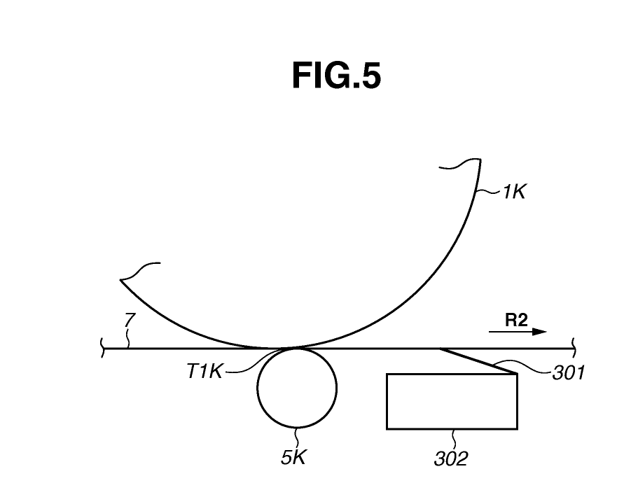

FIG. 5 is a schematic cross-sectional view illustrating a vicinity of the primary transfer portion T1K of the K station according to the present exemplary embodiment. In the present exemplary embodiment, the primary transfer roller 5 also applies an increased pressing force to the photosensitive drum 1 large in diameter in a similar manner to the first exemplary embodiment. Then, the present exemplary embodiment is further characterized in that the image forming apparatus 100 further includes a scraper 301 disposed downstream of the photosensitive drum 1 large in diameter in the conveyance direction of the intermediate transfer belt 7 as a support member that supports the intermediate transfer belt 7 by pressing the inner circumferential surface (the back surface) of the intermediate transfer belt 7 toward the outer circumferential surface side of the intermediate transfer belt 7. As illustrated in FIG. 5, the scraper 301 is held by a holding unit 302, and is brought into contact with the inner circumferential surface of the intermediate transfer belt 7 in such a manner that a free end of the scraper 301 is located upstream of a fixed end of the scraper 301 in the conveyance direction of the intermediate transfer belt 7. This scraper 301 plays a role of supporting the stretched surface of the intermediate transfer belt 7 by pressing the intermediate transfer belt 7 toward the outer circumferential side of the intermediate transfer belt 7 in the vicinity of the downstream side of the primary transfer portion T1K at the K station.

In the present exemplary embodiment, the scraper 301 can be made of a plastic material such as polycarbonate. In the present exemplary embodiment, the scraper 301 is a sheet-shaped member having a thickness of 200 μm. Further, in the present exemplary embodiment, the scraper 301 is arranged so as to enter the back surface of the intermediate transfer belt 7 by an inroad amount of 1.5 mm and to be inclined at 20 degrees as an angle defined between the inner circumferential surface of the intermediate transfer belt 7 and the scraper 301. However, the scraper 301 is not limited to these material, dimension, and arrangement.

The increase in the pressing force applied from the primary transfer roller 5 to the photosensitive drum 1 creates such a tendency that difference in unevenness of the pressing force becomes large in the longitudinal direction of the primary transfer portion T1. To solve this problem, the stretched surface of the intermediate transfer belt 7 is supported by the scraper 301, which can reduce this unevenness of the pressing force in the longitudinal direction. If this unevenness of the pressing force in the longitudinal direction is large, the micro vibration within the nip of the primary transfer portion T1 that is caused due to the difference in the speed of the intermediate transfer belt 7 may be promoted by the unevenness of the pressing force in the longitudinal direction, resulting in occurrence of an in-plane unevenness. However, the provision of the scraper 301 can make it difficult for the in-plane unevenness to occur even when a difference is made in the speed of the intermediate transfer belt 7.

In this manner, in the present exemplary embodiment, the image forming apparatus 100 includes the support member that supports the intermediate transfer belt 7 by pressing the inner circumferential surface of the intermediate transfer belt 7 toward the outer circumferential surface side on the downstream side of the second primary transfer roller 5K in the conveyance direction of the intermediate transfer belt 7. As a result, the present exemplary embodiment can further excellently reduce the influence of the change in the speed of the intermediate transfer belt 7 on the primary transfer portion T1 of the image forming unit S using the photosensitive drum 1 large in diameter.

Next, a third exemplary embodiment of the present invention will be described. A basic configuration and operation of an image forming apparatus according to the present exemplary embodiment are similar to the configuration and the operation according to the first exemplary embodiment. Therefore, components having functions or configurations similar or corresponding to the components according to the first exemplary embodiment will be identified by the same reference numerals, and detailed descriptions thereof will be omitted below.

In the present exemplary embodiment, the primary transfer roller 5 also applies an increased pressing force to the photosensitive drum 1 large in diameter in a similar manner to the first exemplary embodiment. Then, the present exemplary embodiment is further characterized in that the rubber portion (the elastic layer) of the primary transfer roller 5 is shaped into such a crown shape that the outer diameter is increasing from the ends toward the central portion in the longitudinal direction. Then, a crown amount thereof (how much the outer diameter at the central portion increases relative to the outer diameters at the ends in the longitudinal direction) is set to a larger amount at the primary transfer roller 5 located to oppose the photosensitive drum 1 large in diameter than the primary transfer roller 5 located to oppose the photosensitive drum 1 small in diameter.

More specifically, the increase in the pressing force of the primary transfer roller 5 leads to deflection of the primary transfer roller 5, thereby creating a fall at the center in the distribution of the pressing force in the longitudinal direction although the total pressure increases, raising a possibility of a failure to apply the pressure at the central portion in the longitudinal direction. To solve this problem, the pressure distribution is adjusted by the crown shape of the rubber portion of the primary transfer portion 5, which can achieve application of a constant pressing force from the primary transfer roller 5 and formation of a constant nip shape throughout the longitudinal direction. As a result, the present exemplary embodiment can eliminate the unevenness in the pressure distribution in the longitudinal direction, thereby succeeding in further reducing the influence of the unevenness of the speed of the intermediate transfer belt 7 on the primary transfer portion T1.

In the present exemplary embodiment, both the primary transfer roller 5 located to oppose the photosensitive drum 1 small in diameter, and the primary transfer roller 5 located to oppose the photosensitive drum 1 large in diameter have the crown shapes. However, the primary transfer roller 5 located to oppose the photosensitive drum 1 small in diameter does not have to have the crown shape.

In this manner, in the present exemplary embodiment, at least the second primary transfer roller 5K has the crown shape with the larger crown amount than that of the first primary transfer rollers 5Y to 5C. As a result, the present exemplary embodiment can further excellently reduce the influence of the change in the speed of the intermediate transfer belt 7 on the primary transfer portion T1 of the image forming unit S using the photosensitive drum 1 large in diameter. The configuration according to the present exemplary embodiment may be combined with the configuration according to the second exemplary embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-107609, filed May 23, 2014, which is hereby incorporated by reference herein in its entirety.

What is claimed is:

1. An image forming apparatus comprising:
a first photosensitive drum, having a first outer diameter, configured to bear a toner image;
a second photosensitive drum, having a second outer diameter larger than the first outer diameter, configured to bear a toner image;
an endless movable intermediate transfer belt configured to temporarily bear the toner images, the toner images being transferred from the first and second photosensitive drums and then transferred onto a recording medium;
first and second transfer rollers configured to electrostatically transfer the toner images formed on the first and second photosensitive drums onto the intermediate transfer belt, respectively;
a first urging member configured to urge the first transfer roller toward the first photosensitive drum across the intermediate transfer belt with a first urging force;
a second urging member configured to urge the second transfer roller toward the second photosensitive drum across the intermediate transfer belt with a second urging force larger than the first urging force;
a cleaning member configured to electrostatically remove toner on the intermediate transfer belt at a cleaning portion located upstream of a primary transfer portion and downstream of a secondary transfer portion in a rotational direction of the intermediate transfer belt;
a switching unit configured to switch a first image forming mode and a second image forming mode, the first and second photosensitive drums and the intermediate transfer belt being brought into contact with each other to transfer the toner images from the first and second photosensitive drums onto the intermediate transfer belt in the first image forming mode, the second photosensitive drum and the intermediate transfer belt being brought into contact with each other to transfer the toner image from the second photosensitive drum onto the intermediate transfer belt with the first photosensitive drum and the intermediate transfer belt being separated from each other in the second image forming mode; and
an execution portion configured to pass an adjustment toner image through the cleaning portion after forming the adjustment toner image on the intermediate transfer belt in the second image forming mode.

2. The image forming apparatus according to claim 1, further comprising:
a detection unit configured to detect the adjustment toner image; and
a setting portion configured to set an image forming condition based on a result of the detection by the detection member,
wherein the execution portion passes the adjustment toner image through the cleaning portion after the detection unit detecting the adjustment toner image, the adjustment toner image being formed on the intermediate transfer belt in the second image forming mode.

3. The image forming apparatus according to claim 1, wherein the second transfer roller for the second photosensitive drum is disposed on a downstream side of the first transfer roller for the first photosensitive drum in a movement direction of the intermediate transfer belt.

4. The image forming apparatus according to claim 1, further comprising a transfer member urged toward the intermediate transfer belt and configured to transfer the toner images from the intermediate transfer belt onto the recording medium at a transfer portion,
wherein the execution portion separates the intermediate transfer belt and the transfer member from each other when the adjustment toner image on the intermediate transfer belt passes through the transfer portion.

5. The image forming apparatus according to claim 1, further comprising a support member disposed in contact with an inner circumferential surface of the intermediate transfer belt on a downstream side of the second transfer roller in a movement direction of the intermediate transfer belt, and configured to support the intermediate transfer belt.

6. The image forming apparatus according to claim 1, wherein the first and second transfer rollers each have such a crown shape that a diameter is larger at a central portion than an end portion in an longitudinal direction, and a crown amount of the second transfer roller is larger than a crown amount of the first transfer roller.

7. The image forming apparatus according to claim 1, wherein the intermediate transfer belt includes a plurality of layers, and a layer on an outer circumferential side has a lower hardness than a layer on an inner circumferential side.

8. The image forming apparatus according to claim 1, wherein a plurality of photosensitive drums including the first and second photosensitive drums is arranged along a movement direction of the intermediate transfer belt, and the second photosensitive drum is disposed downstream of other photosensitive drums among the plurality of photosensitive drums in the movement direction of the intermediate transfer belt.
